(19) United States
(12) Patent Application Publication
(10) Pub. No.: US 2004/0074720 A1
(43) Pub. Date: Apr. 22, 2004

(54) Motion stabilized mounts

(76) Inventor: Gary Peter Thieltges, Los Angeles, CA (US)

Correspondence Address: Gary Peter Thieltges, 2214 Panorama Terr., Los Angeles, CA, 90039, US

(21) Appl. No.: 10/431,090

(22) Filed: May 7, 2003

Related U.S. Application Data
(60) Provisional application No. 60/378,623, filed on May 7, 2002.

(51) Int. Cl. F16F 9/00

(52) U.S. Cl. 188/318

(57) ABSTRACT

A bi-directional shock and vibration dampener, which affords isolation from undesirable motion in one axis while maintaining positional rigidity on another axis. The invention consists of an attachment with bearings conformed along a shaft to allow axial movement between them. The shaft may be attached with a close tolerance piston centered in a cylinder dividing the cylinder into two chambers. Internal springs and transfer of gas or fluid between chambers achieve bi-directional dampening. Alternately, the dampning effect may be achieved externally to the assembly. In another mount configuration, a gimbal mount with angular deflection sensors and servo drive may be used to maintain desired position relative to horison for motion picture cameras or other equipment. Angular position is held constant while the atachment changes angle on a single plane. Motion picture cameras or other equipment may thus control motion on one axis while maintaining positional stability on another axis

The present invention provides motion stabilized mounts such as platforms and harnesses. In one embodiment, the motion stabilized mount may be a motion stabilized camera platform that may be used, for example in the filming industry and may be affixed to a moving vehicle such as a car, boat, motorcycle or the like. Because of the motion stabilization, the images recorded using the motion stabilized cameras are stable and do not include the vibration, jarring and oscillation experienced by the vehicle to which they are attached. Another exemplary application is motion stabilized platforms that may be used to mount machinery such as a computer which is resistant to shock and building vibration, such as from an earthquake or the like. Another exemplary embodiment is a motion stabilized harness for retaining a recording instrument such as a camera, in a horizontal position when the vehicle to which the harness is secured, experiences angular motion with respect to the horizontal.

First Exemplary Embodiment—Motion Stabilized Platform

In one exemplary embodiment, a bi-directional shock absorber and vibration isolator with adjustable dampening is provided.

The shock absorber device consists of a cylinder and a shaft conformed in such a way as to allow axial movement between cylinder and shaft thus absorbing shock and vibration while dampening the effects of such shock. The device effectively controls shock or vibration in either direction of axial movement and includes a centering feature. Additionally the device allows shock and vibration control in one axis only while affording structural integrity.

A shaft runs axially through the cylinder and is supported at each end of the cylinder by a low friction bearing (linear ball bearing) allowing free travel along the axial line. A piston with very close tolerance to the ID of the precision cylinder is attached to the center of the shaft. A gasket may optionally be affixed to the diameter of the piston to achieve a close seal to the cylinder wall. Additional gaskets may be used on the linear bearings to achieve a seal to the shaft. A pair of compression springs may be used, with each spring placed in each chamber of the cylinder created by the piston with one end affixed to the piston and the other end affixed to the bearing end of the cylinder. The springs act to center the piston in the cylinder and allow the two components to move axially against each other while acting to absorb any impact of movement between the two objects. The springs used are set at a calculated spring rate to the load the device is to carry. In one embodiment, the two springs may be of the same stiffness (spring rate) and in another embodiment, such as when the shock absorber is oriented vertically, the springs may be of different stiffness.

Gas or fluid in the two cylinders is forced through the close fit of piston to wall or through a valve arrangement from one cylinder to the other cylinder. This achieves a progressive dampening effect. As the piston moves in one direction compressing the spring, the gas or fluid flow is restricted thus dampening the action. As the springs compress to absorb the shock and then rebound, the restricted flow of gas or fluid also dampens the return of the spring thus providing a uniform and controlled action. The damping effect allows the device to control the compression and rebound of the spring as well as controlling the shock effect in either direction. This spring and dampening act to absorb the impact of a shock allowing the attached device to move independently of the attachment.

The ends of the shaft provide an attachment to the source of the shock or vibration. The cylinder provides an attachment to the object to be isolated from shock or vibration. The object to be isolated is thus allowed to move independently and thus provided isolation from the shock and vibration. This attachment arrangement may be reversed if desired for particular applications. The object or surface to which the device is attached to may thus bump or vibrate and the device will diminish the transmission of this action to the object attached to the device.

A set damping effect may be achieved in this manner. A variable dampening effect may be achieved by use of valves in the piston used to adjust the flow of gas or fluid between the two chambers. In one embodiment, externally adjustable dampening may be achieved by the use of a tube connecting the two chambers through which the gas or fluid may pass from one chamber to the other. A valve assembly on such tube may be used to control the rate of flow and thus the dampening effect.

The device may be used vertically or horizontally or in combination to control vibration and shock in a variety of situations and applications. The device may used singly, in pairs or multiples to afford shock and vibration control along one, two or three axis.

Additional devices such as gyros may be attached to the object to be isolated to further resist the effect of the unwanted motion from being transmitted to the isolated object.

An arrangement of multiples of the unit configured along two axis may be used to create a platform on which to support a camera used in the motion picture industry, for example. The arrangement may be affixed to a car, boat, or on the like which is susceptible to irregular movement and vibration. The arrangement of the preset invention absorbs and dampens the motion.

In another embodiment, delicate instruments or computers may be mounted on the arrangement to isolate them from vibration and shock in a building or during an earthquake. The device may also be used in various arrangements of multiples to isolate the source of vibration such as an air compressor or pump from transmitting the vibration to the rest of a building.

The device may be arranged in a set of four units configured vertically in a rigidly fixed manner with the four moveable shafts rigidly tied together and attached to an object to suspend the object and isolate the object from vertical disturbance. This arrangement allows structural integrity, holding the object structurally in two axis but allowing free motion and isolation in the vertical plane.

The above structure may also incorporate additional pairs of the devices set in parallel arrangement on the opposite horizontal axis and attached in a manner that allows isolation on the two horizontal axis as well (such an isolation device may be used for a motion picture camera, for example).

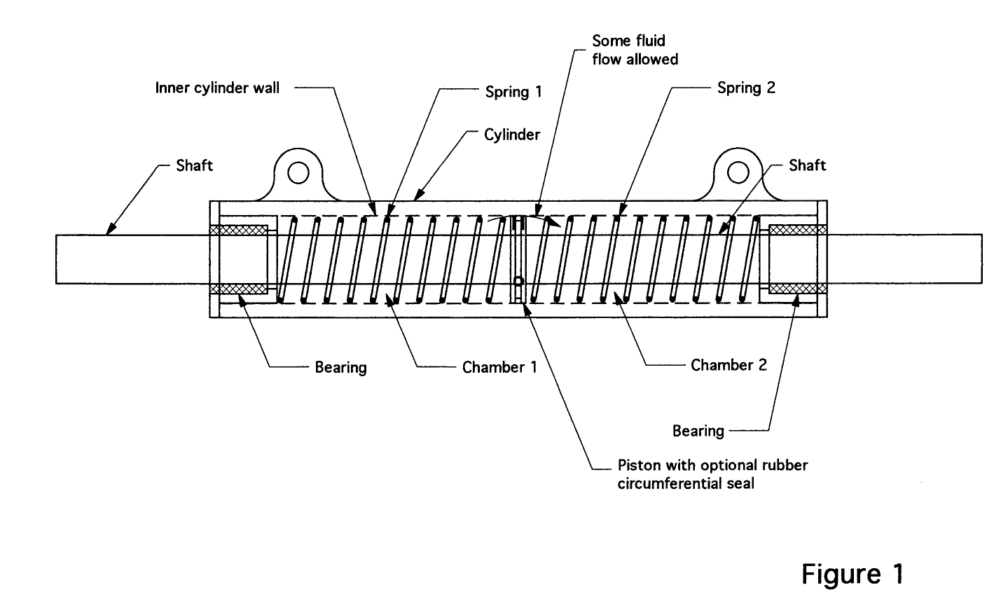

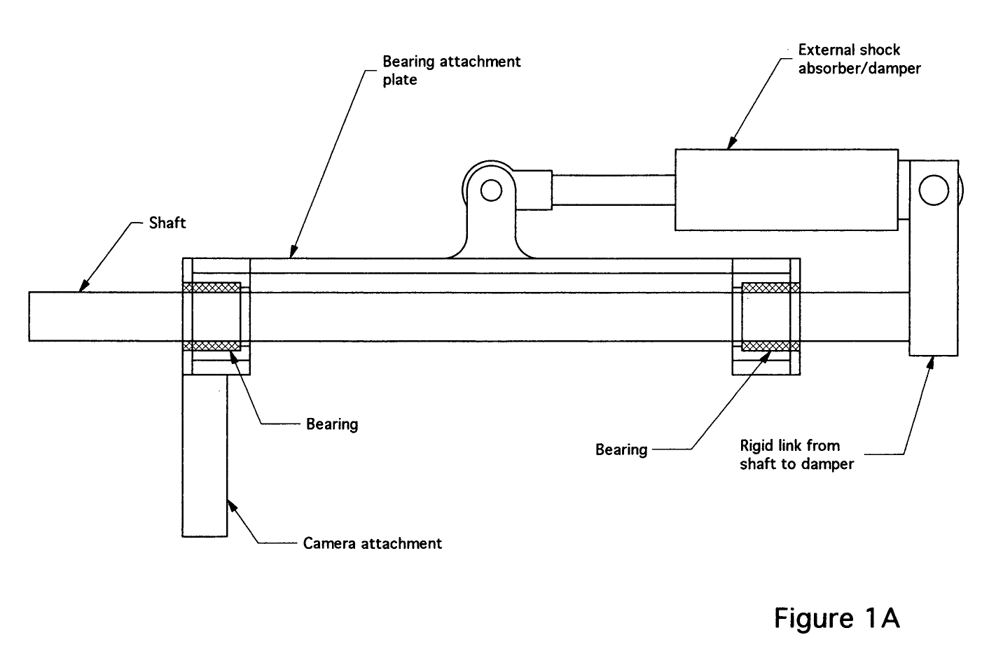

Various exemplary embodiments of the motion stabilized mount/platform according to the first exemplary embodiment, are shown in FIGS. 1-6.

FIG. 1 shows a cross-section of an individual cylinder (“bi-directional shock absorber”) of this embodiment. The shaft extends through the cylinder and is affixed to a piston with an optional rubber circumferential seal. The cylinder is divided into two chambers separated by the piston. Spring 1 and Spring 2 are provided in respective chambers and may be chosen to include the same or a different stiffness. Springs 1 and 2 seat at the end of the tubes adjacent the low friction bearings. The piston and/or optional rubber circumferential seal may allow some fluid flow between the seal and the inner cylinder wall.

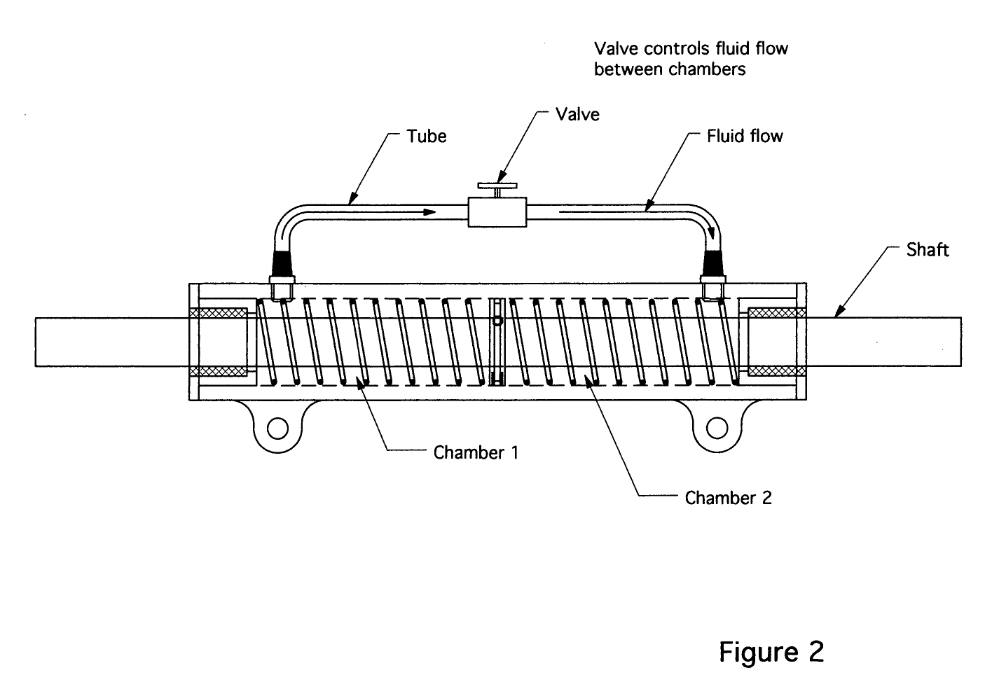

FIG. 2 substantially shows the arrangement of FIG. 1 and also including tubing and a valve that controls fluid flow between the chambers and provides a variable damping effect. The valve may be adjusted to adjust the damping between the chambers.

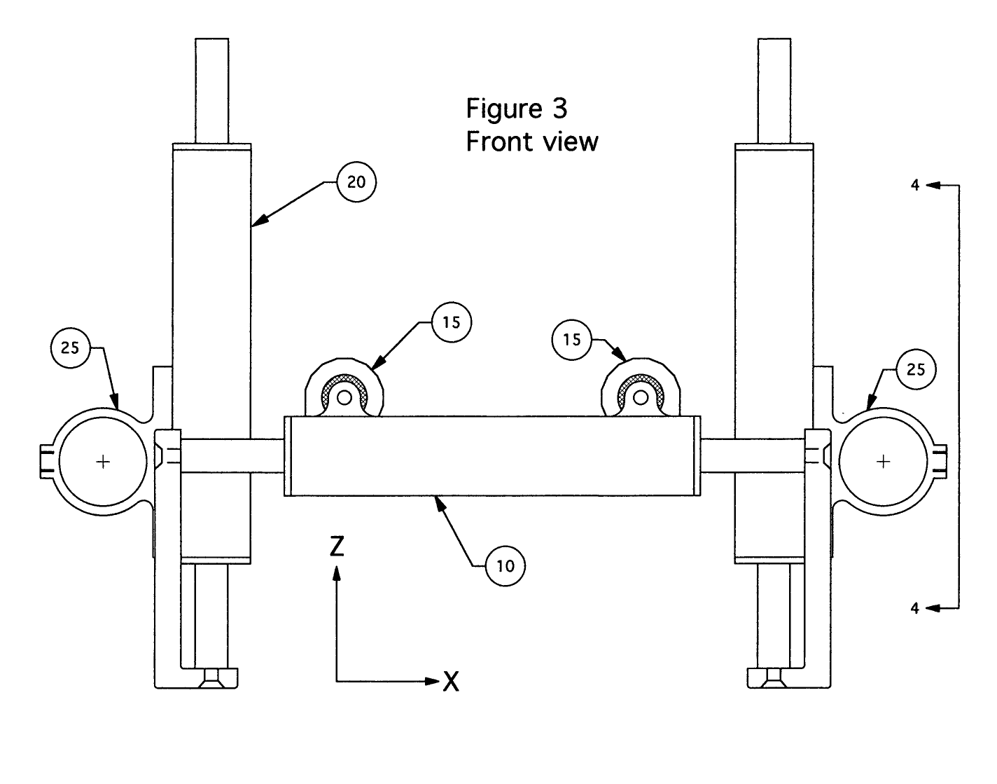

FIG. 3 is a front view of an exemplary embodiment in which eight of the shock absorber/cylinders of the present invention are used. Cylinders 10 are along the X direction, cylinders 15 are along the Y direction, and cylinders 20 extend along the Z direction.

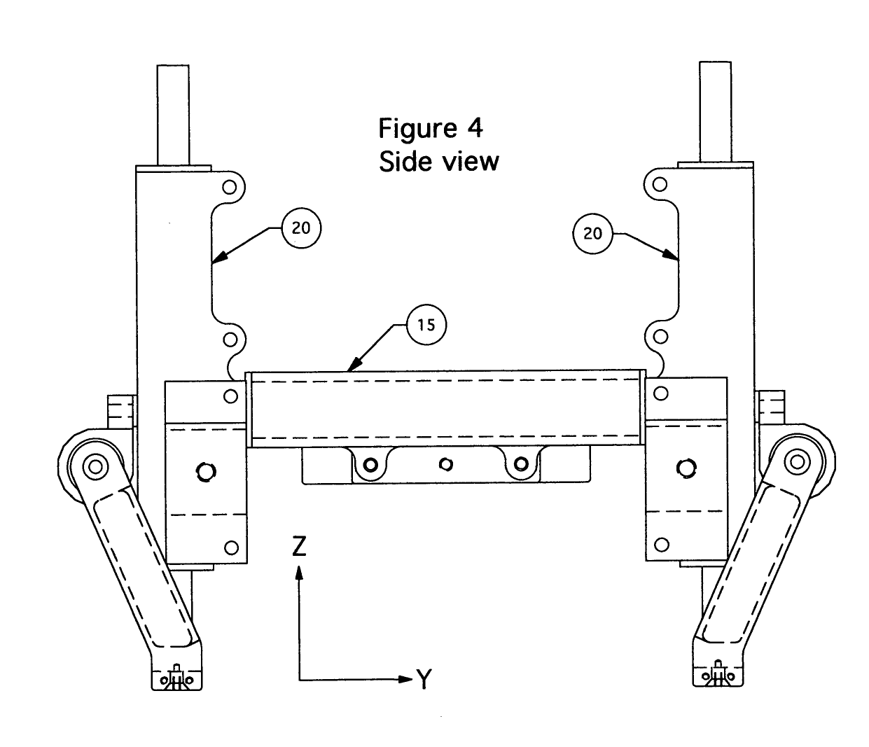

FIG. 4 is a side view taken along line 4-4 of FIG. 3.

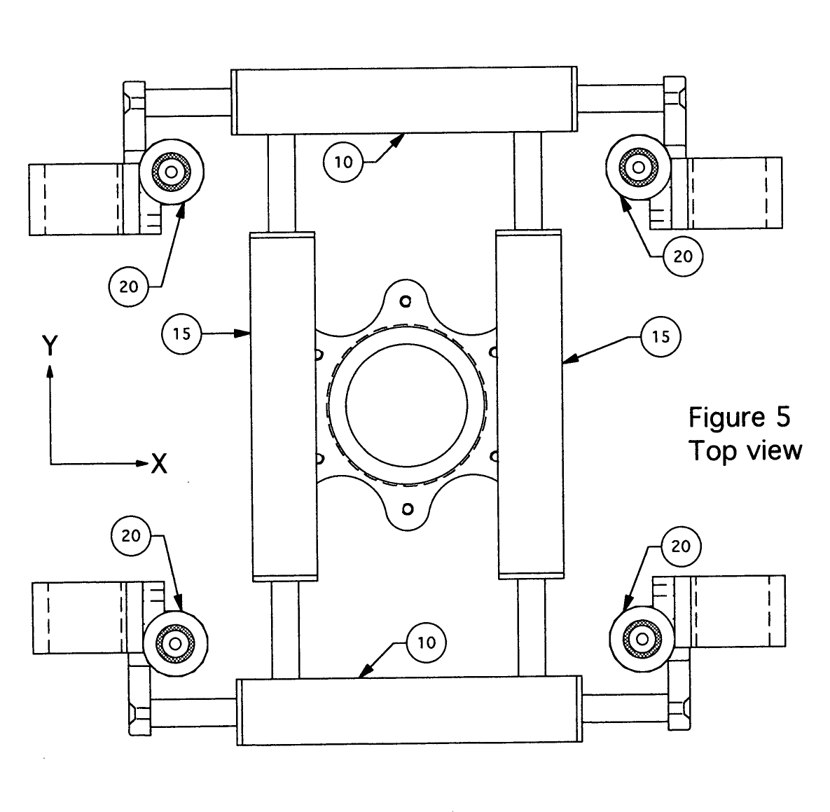

FIG. 5 is a top view of the arrangement that provides bi-directional shock absorption and vibration isolation in three dimensions.

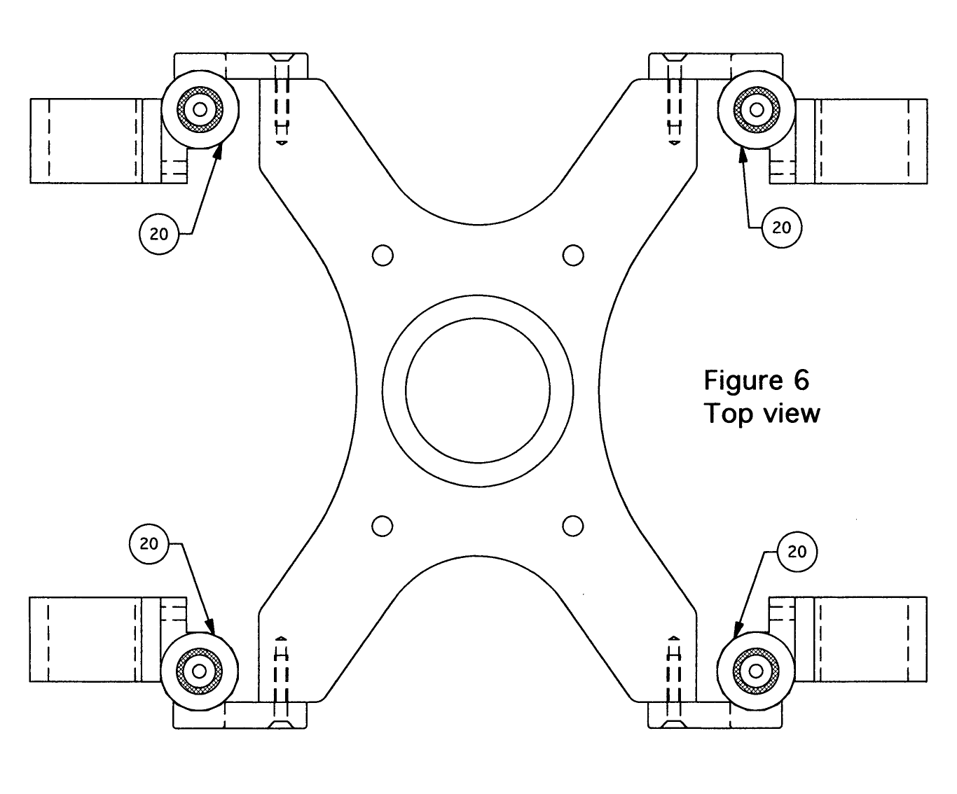

FIG. 6 is a top view of an exemplary arrangement in which motion stabilization is provided in the Z direction only.

Photographs 1-8 further explain and illustrate the motion stabilized platform of this first exemplary embodiment. Photograph 1 is a top, perspective view of an arrangement of 8 shock absorber/cylinders which provide motion stabilization in three dimensions. Photographs 2 and 3 are additional perspective views showing the arrangement illustrated in photograph 1. In each of photographs 1-3, a harness securing the camera is suspended from the arrangement. Photograph 4 is a perspective view of the arrangement in which four substantially parallel cylinders are provided to provide motion stabilization in the Z direction. Photograph 5 shows the arrangement of Photograph 4 affixed to speed rails. “Speed rails” are tubular elements which are commonly used in the motion picture industry as supports for a range of things, such as lights, camera mountings and the like. Each of Photographs 4 and 5 show a harness including an exemplary camera, suspended from the arrangement. Photographs 6 and 7 show a two-dimensional configuration of this embodiment. Photograph 6 shows the arrangement substantially in rest position and Photograph 7 shows the arrangement displaced responsive to a force supplied in the X direction. Photograph 8 shows the two-dimensional arrangement shown in Photographs 6 and 7, with an exemplary camera lens affixed to the platform.

Second Exemplary Embodiment—Gimbal to Hold Horizontal Level on one Axis for Camera Mount

This embodiment produces a device which allows the attachment of an object such as a camera to a member such as a motorcycle or cable which has variance in angle to the horizon on one axis. A motorcycle may achieve many angular positions with respect to the horizontal. As a motorcycle drives through a corner for example, the cycle leans into the turn thus changing the angle of the cycle and a camera mounted fore or aft of the bike to the horizon on that one axis. In the case of the cable suspension of a camera, the droop of the cable over a span or the change in altitude will cause a change of angle of horizon when viewed perpendicular to the length of the span.

The camera mount gimballing device provides horizontal stabilization of the camera or other object when the member such as the motorcycle changes its angular orientation with respect to the horizontal. The camera mount gimballing device consists of two end plates which are (fixed) attached to each other and the object with a variance of angle to the horizon on one axis. Each plate has a bearing in line with the axis of rotational variance. These two bearings arms are mounted vertically to an inter-arm plate adjoining the two arms. Each bearing engages an axle carried by a vertical arm, and the arms are securely interconnected by an inter-arm plate. The arm and their interconnecting, inter-arm plate form a yoke which is angularly moveable about the common axis of the axles, relative to the end plates. The inter-arm plate has a mounting attachment which will allow the suspended attachment of the camera or camera device from the bearing assembly. In one embodiment, a harness configured to hold a camera or other device, is the suspended attachment. A balance mass may be provided and adjusted up and down to adjust the center of mass of the gimballed structure relative to the gimbal axis, i.e., the axis on which the arm axles are aligned, in order to provide an optimal center of gravity. An axle is attached to the supporting arm through the bearing at one end of the device. This axle is driven by a motor and gearbox assembly attached to the end plate so that the arms, the plate adjoining the arms and therefore the attached camera or other harnessed device, may be rotated on the bearings in axial rotation. A sensor can be attached to the camera or the attaching members which senses the angle of rotation of the arms relative to the end plates, in deviance with the horizon. This data is processed and fed to the motor which in turn drives the assembly so as to rotate the axis and maintain the arms, the inter-arm plate adjoining the arms, and the harness including the camera, at a horizon level, responsive to and compensating for, the change of angle of the end plates and member to which the device is attached. Alternatively, the angular deviation sensor can be carried on the device (e.g., the motorcycle) to which the camera is mounted to sense tilt of that device and to output a signal which is a measure of that tilt. That signal can be applied to a motor controller which operates the gear box to drive the arms relative to the end plates to keep the gimballed camera mount in a vertical altitude between the (tilted) end plates.

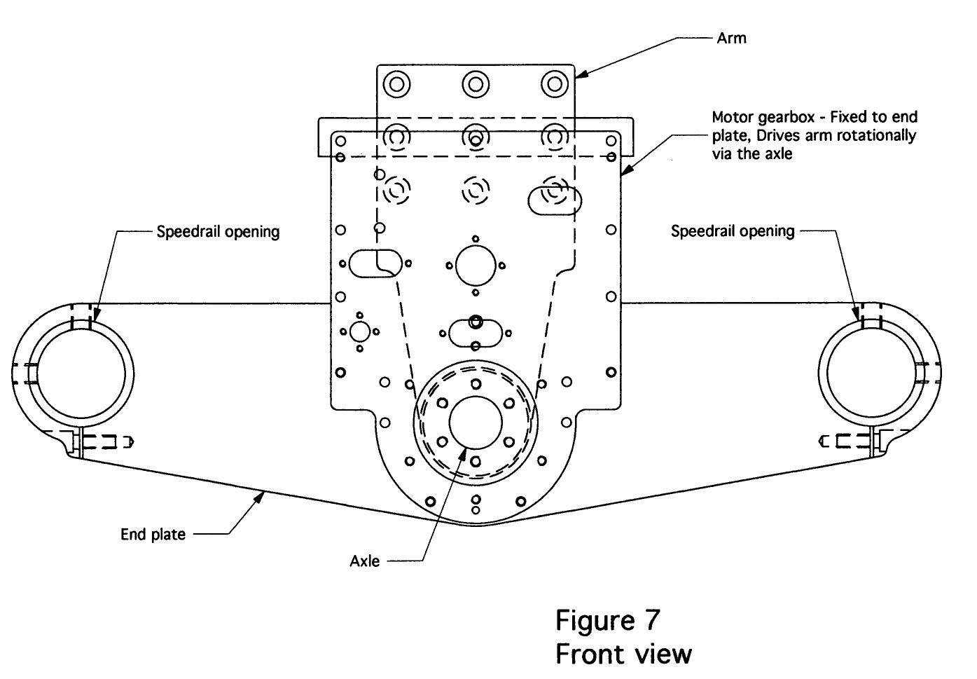

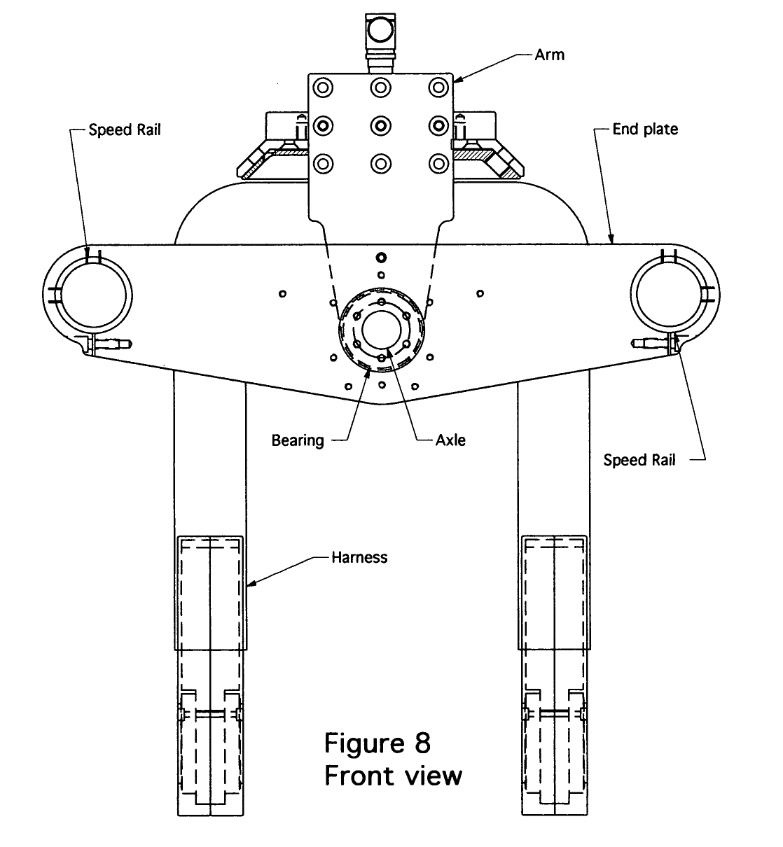

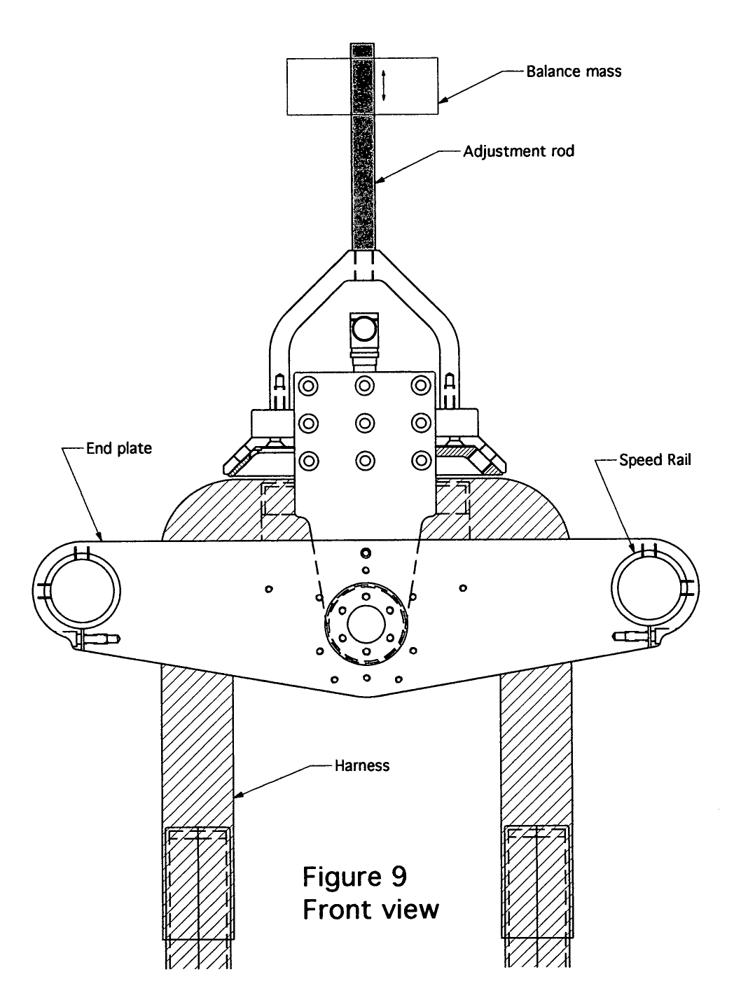

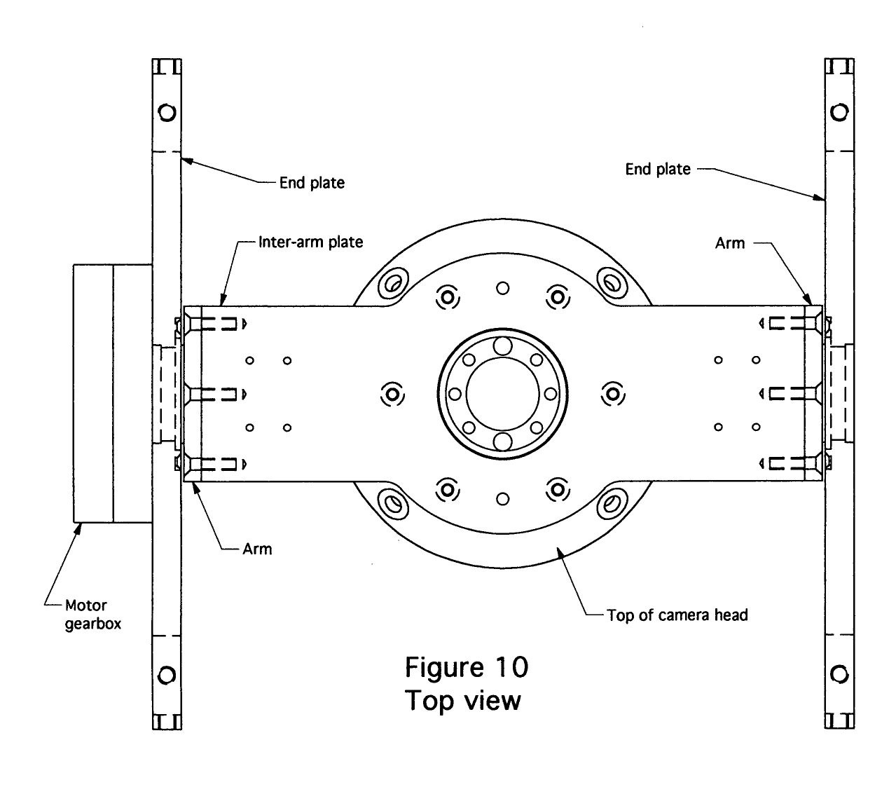

FIGS. 7-10 show various features of the gimballing, horizontal angular stabilization apparatus according to this second exemplary embodiment. FIG. 7 is a front view showing the end-plate affixed to the motor gear box which drives the arm rotationally by way of the axle. The motor gear box receives a signal from an angular sensor, and responsive to that signal, drives the axle through the bearing by way of a gear such as a worm gear. The end plate includes openings to receive a speed rail or other member for fastening the unit to a motorcycle or other vehicle. FIG. 8 shows the arrangement illustrated in FIG. 7 but not including the motor gear box. FIG. 8 further shows the harness which is fixed with respect to the arm by way of the inter-arm plate (which is shown in FIG. 10). The arms, inter-arm plate, harness, and any object such as a camera which may be secured to the harness, remain horizontally stabilized when the end plates become angled with respect to the horizontal. FIG. 9 shows the arrangement of FIG. 8 and additionally including an adjustment rod which may be provided with a balance mass capable of being adjusted to alter the center of gravity of the arrangement gimballed to the end plate. FIG. 10 is a top view showing the motor gear box, the arms, end plates, and an inter-arm plate. The central member represents the top of a camera head or harness which may include and secure various other devices that are desired to remain horizontally stabilized, when the end plates experience angular motion with respect to the horizontal.

Photographs 9-11 further illustrate aspects of the gimballed horizontal angular stabilization unit. Photograph 9 is a perspective view showing the end plate receiving a plurality of speed rails which may be attached to a motorcycle or the like. The speed rails and end plate experience angular motor with respect to the horizontal, when the motorcycle, for example, tilts. Motor gear box includes an opening for an axle to drive the illustrated arm which is connected to the other arm (not shown) by the inter-arm plate which retains the harness which receives the camera. Photographs 10 and 11 also show the arrangement of the second exemplary embodiment. Photograph 11 shows the arrangement in a configuration in which the end plate, gear box and speed rails are angled with respect to the horizontal, but the arms, inter-arm plate and harness are substantially parallel to the horizontal.

1. A body consisting of a close tolerance cylinder with a shaft running through is sealed and supported internally in the cylinder at each end by a linear ball bearing and seal, with a close tolerance piston attached to the center of the shaft dividing the cylinder into two chambers. The shaft is afforded axial motion controlled by springs internal to the two chambers as well as the transfer of gas or fluid from on chamber to the other thus affording control of unwanted motion or vibration.

2. Multiples of the bodies may be arranged in such a manner as to afford motion control in horizontal, vertical or lateral axis or all three at once, offering the isolation of objects such as motion picture cameras or other devices from unwanted motion.

3. Multiples may be arranged in such a manner as to create a platform on which objects such as computers or sensitive equipment may be placed so as to provide isolation from earthquake damage or other unwanted motion.

4. A valve arrangement may be used to control the degree of dampening effect of the transfer of gas or fluid from one chamber to the other.

5. Externally mounted devices may attached to the bearing and shaft assembly so as to afford the dampening and shock absorbtion required.

6. A gimbal assembly may be used to hold an object to be stabilized on one axis relative to the angular change of the attachment through a servo driven gear assembly informed by angular deviation sensors.
